(19) United States
(12) Patent Application Publication
(10) Pub. No.: US 2007/0185860 A1
(43) Pub. Date: Aug. 9, 2007

(54) SYSTEM FOR SEARCHING

(76) Inventor: Michael Lissack, Naples, FL (US)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(21) Appl. No.: 11/626,075

(22) Filed: Jan. 23, 2007

Related U.S. Application Data
(60) Provisional application No. 60/761,458, filed on Jan. 24, 2006.

(51) Int. Cl. G06F 17/30

(52) U.S. Cl. 707/5

(57) ABSTRACT

A system compares two sets of database entries to prepare a list of indexed database entries based on similarity. The system is capable of providing a hypertext linked output displayed according to similarity or other user preferences, and the hypertext links are capable of querying a search engine providing links to resources related to the hypertext linked output. The user may input a source document into the system for generating a related hypertext linked output. A process parses and indexes origin database entries and source database entries and compares some or all of the entries to create the hypertext linked output according to a weighting, such as determined by a similarity search system.

### REFERENCED APPLICATIONS

This application claims the benefit of the filing date of U.S. Provisional Patent Application No. 60/761,458 filed Jan. 24, 2006, the description and figures of which are hereby incorporated herein by reference in its entirety.

### FIELD OF THE INVENTION

The field relates to searching databases and conducting searches of the internet or an intranet such that relevant information to a query is located.

### BACKGROUND OF THE INVENTION

Search engines on the internet use programs to incorporate autonomous and human searching of the internet to create a database, which may be indexed. A search using the search engine returns a list of hits on web pages that may be available for viewing on the internet. The arrangement of the hits is organized by parameters of the search engine based on paid subscriptions, frequency of hits on a website, the number of links on to the website from other websites, and other parameters, for example.

There are a large number of search engines for searching documents found on the internet and/or located in a database stored on a computer intranet. Creation of wealth is increasingly based on the generation, organization and use of information in the Information Age. If organizations are to successfully collect and classify vast amounts of data, then, the data needs to be indexed and searchable in a way that increases relevance and improves focus on the relevant topics.

Organizations typically produce vast quantities of information which they or their stakeholders may wish to re-access or to serve to others at some later time. This need for re-accessing and serving has driven organizational demand for classification systems. At the same time, the emergence of the Information Age has created a wealth of information that is available electronically. Unfortunately, much of this information is often impractical to access by individuals, because they do not know where to look. Even if an individual knows where to look for the information, the volume of information available causes retrieval of desired information to be inefficient.

The need for efficient document storage, searching and retrieval of focused information is well known; however, no commercial system provides a system of learning that is capable of both focusing a search of the intranet and internet and making the results of search relevant to a source document covering a specific topic.

Internet based searches require too much time to sort through meaningless or misleading information and advertisements. Multiple hits resulting from the results of search engine queries may be excessive in number and are also often frustratingly irrelevant to the particular information an individual was seeking. Therefore, such hits may be of little interest and of minimal value to the searcher. Individuals and researchers have learned that keyword searches are not very reliable or easy to conduct, especially if boolean operators must be used to limit the search. Too often, irrelevant sites are not eliminated, but relevant sites are missed.

The World Wide Web contains billions of static and dynamic web pages, and content is growing at an accelerating pace. To efficiently access web pages of interest to people using web browsers, software developers have created web sites that operate as search engines or portals. A typical conventional search engine includes one or more web crawler processes that are constantly identifying newly discovered web pages. This process is frequently done by following hyperlinks from existing web pages to the newly discovered web pages. Upon discovery of a new web page, the search engine employs an indexer to process and index the content such as the text of this web page within a searchable database by producing an inverted index. Generally, an inverted index is defined as an index into a set of texts of the words in the texts. A searcher then processes user search requests against the inverted index. When a user operates his or her browser to visit the search engine web site, the search engine web page allows a user to enter one or more textual search keywords that represent content that the user is interested in searching for within the indexed content of web pages within the search engine database. The search engine uses the searcher to match the user supplied keywords to the inverted indexed content of web pages in its database and returns a web page to the user's browser listing the identity (typically a hyperlink to the page) of web pages within the world wide web that contain the user supplied keywords. Popular conventional web search engines in use today include Google¹ (accessible on the Internet at http://www.google.com/), Yahoo!² (http://www.yahoo.com/), MSN³ (http://www.msn.com) and many others. ¹ Google is a registered trademark of Google, Inc.² Yahoo! is a registered trademark of Yahoo, Inc.³ MSN is a registered trademark of Microsoft Corporation.

Taxonomies were developed by a biologist in the 1800's to classify plants and animals. Plants and animals are real entities: a rabbit vs. a cow or a rose vs. a sunflower. These are groups of objects that are easily understood and identified by the concrete differences in their attributes. Taxonomies have been adapted for use in classifying information. Categories of subject matter replace what in the original methodology were entities (i.e. plants and animals). Documents have differences, but these differences can often be abstract and/or very subtle. This usually means the differences are qualitative and require significant effort to create and maintain.

The largest enterprise taxonomy is around 40,000 hierarchical categories. If an organization had 40 million documents in your information pool on average each category would contain roughly 1000 entries. These 1000 entries represent the granularity of the classification technique applied to this information. A thousand documents are a lot for the user to sift through, so either the user has the burden of coming up with additional search constraint words to reduce the result set or a search engine must provide the user's most relevant results at the top of the list.

With regard to the Internet the numbers are far more staggering. While a web taxonomy may involve as many as a half million hierarchical categories (e.g. the magnitude of the Yahoo! Directory), the number of documents is in excess of 5 billion. On average each category would contain roughly 10000 entries. These 10000 entries represent the granularity of the classification technique applied to this information. Ten thousand documents are far too many for the user to shift through, so either the user has the burden of coming up with additional search constraint words to reduce the result set or a search engine must provide the user's most relevant results at the top of the list.

A problem with using current search technology is that web searching and enterprise searching are not consistently providing acceptable search resolution for the user. The missing ingredient in current search technology is “true relevance”. Relevance can only be defined by the user for a specific search. Relevancy has no predictable pattern. No generalized algorithm is going to repeatably produce relevant information, because in the end, any generalization is arbitrary.

What has occurred, so far in the industry, is a fragmentation of search applications as vendors try to address niche search markets in an attempt to improve relevancy by narrowing the domain. For example, sites that are product specific, area-of-interest specific, group specific, or subject specific, have all been implemented. So far, there have been no successful generalized search applications that consistently provide high levels of relevancy.

What are needed are search methods and systems that can efficiently generate search results that are relevant to the particular user's interest. The organizational approach to the problem of information “finding” has focused on classification methods. These can be categorized as mechanical (i.e. human based) automatic (i.e. computer based) and hybrid. Manual classification relies on individuals reviewing and indexing data against a predetermined list of categories. While manual approaches benefit from the ability of humans to determine what concepts a data represents, they also suffer from the drawbacks of high cost, human error and relatively low rate of processing.

No known data classification approach provides a fast, low-cost and substantially automated means to classify large amounts of data that is consistent with the semantic content of the data itself. Others have sought to provide a mechanism to determine a collection of topics that are explicitly related to both the domain of interest and the data corpus analyzed.

### Definitions

As the number of documents and documents like objects on the Internet and in corporate enterprise systems continues to multiply, it is unreasonable to assume that users will be also willing to browse through an ever increasing number of search “results” in response to a query. There exists a need for a new approach to narrow search results in a manner that will respect both the inventions and cognitive limitations of the searcher submitting a query and provide a means for improving the relevance of results returned to that searcher.

Various aspects of a system of the present invention are described using terms as described herein. A “user” is an individual reader encountering a portal by means of a user interface. The user is the party clicking on hypertext links as displayed by the interface and/or portal pages. A “publisher” is a party who contributes a source document for the construction of a portal. A “repository provider” is a party who has control of the main document repository against which the source document is first searched. An “external search engine” is a search engine or similar type query mechanism used to submit the results of the first level searches to a database which then produces a second level of search results. For example, the external search engine could be a web-based public search engine such as Yahoo! or Google, could be a proprietary, subscription search engine such as Lexis-Nexis⁴, or a corporate database search query mechanism such as provided by Verity⁵, Autonomy⁶ or Google to search corporate databases and document repositories. In each instance the user, the publisher, the repository provider and the party which provides the external search engine could be separate parties or could be one and the same party. A “main document repository” is a collection of documents which form the basis of the first level search. The main document repository is under the control of the repository provider. ⁴ Lexis-Nexis is a registered trademark of Reed Elsevier Properties, Inc.⁵ Verity is a registered trademark of Verity, Inc.⁶ Autonomy is a registered trademark of Autonomy Corporation.

A “chunk” is any of the following: a phrase of specified word length, one or more sentences, paragraphs, or groupings of paragraphs from within a document or any subsection of document parsed and extracted in accordance with such rule or combinations thereof, as illustrated in FIG. 1 and FIG. 2. A “document of origin” is the source material from which chunks are derived. Thus, for a book which is converted into an electronic format and then broken down into chunks, the document of origin is the electronic copy of the book or subsections thereof from which the chunk was derived. If the book contains chapter subdivisions, the document of origin may also refer to the chapter of origin.

A “source document” is a textual work in excess of 1000 words. The source document is expressed in a computer recognizable electronic format. Thus, while the source of the source document could be a printed book, the book itself is not a source document until it has been converted into a computer recognizable electronic format (e.g. the pages of the book could be fed into a scanner, the resulting images could then be subjected to an optical character recognition process, and then the resulting text would be a source document.) Source documents are commonly expressed in words, sentences, and paragraphs and may have still further organizational metadata included therein such as section headings, chapters, pages, etc.

A “repository relational database” is a relational database which holds within it the contents of the main document repository. Within the repository relational database each of the documents is held in several formats 1) as a whole (though this may be omitted); 2) divided in chunks per the chunking rule selected by the repository provider; 3) metadata such as author, publisher, page references etc; and identifiers which allow the chunks to be associated with their document of origin, the chunks to be associated with the meta data of the document of origin, and the document of origin or some subsection thereof to be reassembled from the collection of chunks which originated within that document or section thereof.

A “similarity search software” examines submitted chunks against a set of target text objects to determine the extent of similarity between the submitted chunks and each object of the set. Measures of similarity include, but are not limited to, semantic space vector analysis, schema analysis, latent semantic analysis, and attribute analysis. “Semantic space vector analysis” uses co-occurrence information to construct a multi-dimensional semantic space in which linguistic units are represented by vectors whose relative distances represent semantic similarity between the linguistic units. “Schema analysis” is a technique to analyze schema language structure and ontology domain. “Latent semantic analysis” is a mathematical/statistical technique for extracting and representing the similarity of meaning of words and passages by analysis of large bodies of text.

“Parsing” is the process of subdividing a source document into chunks. “Parsing software” is software or subroutines which divide textual documents into chunks. A “parsing and search aggregator” is the system that carries out the parsing and search instructions of the present invention. The parsing and search aggregator will have a parsing software component, a similarity search software component and a set of subroutines for moving data into and out of each component and into and out of the repository relational database and the source document relational database.

“Portal software” is used to produce and maintain a web portal. Portals provide access to information networks and/or sets of services through the World Wide Web and other computer networks. Portals are capable of presenting multiple web application views within a single web interface. In addition to regular web content that can appear in a portal, portals provide the ability to display portlets (self-contained applications or content) in a single web interface. Portals can also support multiple pages with menu-based or custom navigation for accessing the individualized content and portlets for each page. A working portal can be defined by a portal configuration. The portal configuration can include a portal definition such as a file including Extensible Markup Language (XML); portlet definition files for any portlets associated with the portal; java server pages (JSPs); web application descriptors; images such as graphics interchange format files (GIFs); deployment descriptors, configuration files, the java archive (JAR) files that contain the logic and formatting instructions for the portal application; and any other files necessary for the desired portal application.

### SUMMARY OF THE INVENTION

A system of searching uses an origin document indexed using a similarity algorithm and stored as a group of indexed chunks in a database, such as a relational database, and a source document parsed into chunks. The source chunks are assigned identifiers in an aggregating step and stored in source database entries, which may be stored in a source database or in a common database with indexed chunks of the origin document. Whether stored separately or in a common database, the origin database and the source database may contain any number of documents for use in the system of searching, and each document may be searched separately or together with other documents entered into the database or databases. Regardless, some set of origin database entries and some set of source database entries are compared by the system to create a catalogue of similar chunks between the origin database entries and source database entries, which may be ranked and listed according to rules in the step of comparison, such as by historic preferences, greatest similarity, frequency and/or other parameters selected by the user of the system.

One advantage of the system is that a large origin document or large number of origin documents may be compared to a large source document or large number of source documents. Another advantage is that a similarity search algorithm may be used to order the results of the comparison. Thus, if the origin document contains information about topics relevant to the user, then a list of similar entries in the source document may also be relevant to the user. Yet another advantage is that information from the source document and/or the origin document may be used as a search string for a subsequent search of the internet or an intranet to locate information relevant to the user.

For example, a user may be provided a list of links to relevant information in a source document that is identified by similarity to information contained in an origin document. By selecting, either manually or automatically, one or more links, the text in a chunk corresponding to the link may be used to form a text string to be used in a query of the internet or intranet, such as by using an internet search engine, which is a database of information available using the internet that is catalogued and capable of providing a list of relevant information on the internet and taking the user to an indexed internet protocol address where the information resides, for example. A ranked list, such as a list ranked by similarity using a similarity search system, may be used to identify one or more items in the list, which are input into a search engine, and the search engine returns a list of identified entries using a weighting algorithm to identify the order and subset of all identified entries. The list may be identified to a user who may select from a list identifying a summary. The user may be allowed to select an entry on the list to retrieve the full entry or to be directed to information in the search engine database, the internet, the origin document, the source document, or each of these, depending on the preferences and selection of the user.

Yet another advantage is that a user is capable of retrieving information easily based on a correlation with the parsed chunks of any two sets of database entries, and the two sets of database entries may be linked to relevant informational resources using a search engine connected to the internet or intranet. The information may be displayed to the user in a familiar format, such as a list of links to relevant information, preferably listed in order of relevancy to the search being conducted by the user.

Another advantage is that a system for learning according to examples of the present invention may be more than a means of finding pre-existing and relevant information based on keywords. Instead, the system is capable of generating a web portal designed to have information relevant to the user, based on information contained in source text provided by the user, a reference librarian, and/or other consultant. An end user of a system for learning may be directed to a web portal, which has already been published—and thus has topical information and metadata about its subject matter and relevance already available—or, if an end user is a publisher of documents, has been created based upon an origin and/or source documents, such as books, articles, encyclopedia entries, and/or a paper. Preferably, the origin/source documents may contain more than 1000 words, which the user has entered into the system and from which a customized web portal may been produced.

Yet another advantage is that a system of learning is capable of converting information in a plurality of data environments into web portals, including enterprise wide systems and Internet web pages. For example, using this system any text in electronic form may be converted into a research oriented web site, which the user may use to locate concepts of interest within the text. With a single click, a user may see associated reference materials. With a second click, a user may make use of the associated references, such as to browse the World Wide Web and other Internet or intranet resources in a limited, relevant search. The system allows publishers or licensees to make use of the contents of a book or lengthy text as a guide for exploration of the World Wide Web, the Internet, or other electronic databases, for example.

Still another advantage is that a system of learning as described herein is capable of narrowing the display of information obtained from a plurality of data environments including web portals, enterprise wide systems and Internet web pages into a display which is of “relevance” to the immediate user or to that user's search or research question. For example, using this system any text in electronic form may be converted into a search query or a defined target of interest about which additional information is desired. The system would process this initial text into a user oriented web site, on which the user may locate further concepts of interest. With a single click, a user may see descriptors of associated materials drawn from the plurality of data environments which have contributed material(s) to the repository database. With a second click, a user may make use of the displayed descriptors to either link to the associated materials themselves, or to trigger a second search based on the contents of such materials as an expanded search query, or to see the predefined results of a search based on said descriptors with regard to the World Wide Web and other internet or intranet resources. The system allows publishers or licensees to make use of the contents of a content management system (such as used by newspapers, textbook publishers, database aggregators, and web portal publishers) or a wicki or a blog as a guide for exploration of the World Wide Web, the Internet, or other electronic databases, for example.

### BRIEF DESCRIPTION OF THE DRAWINGS

The drawings illustrate examples of the present invention.

FIG. 1 illustrates documents containing sections and chunks.

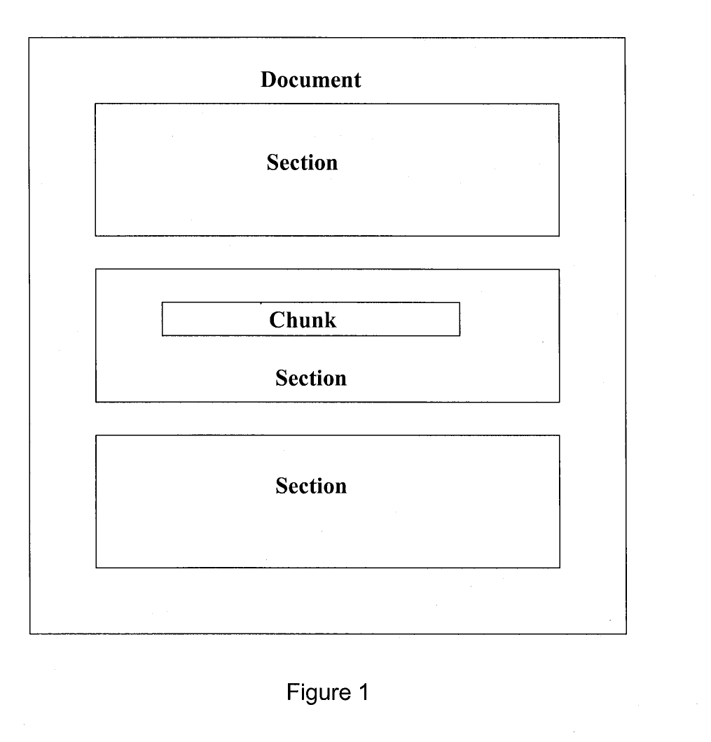

FIG. 2 illustrates examples of chunks.

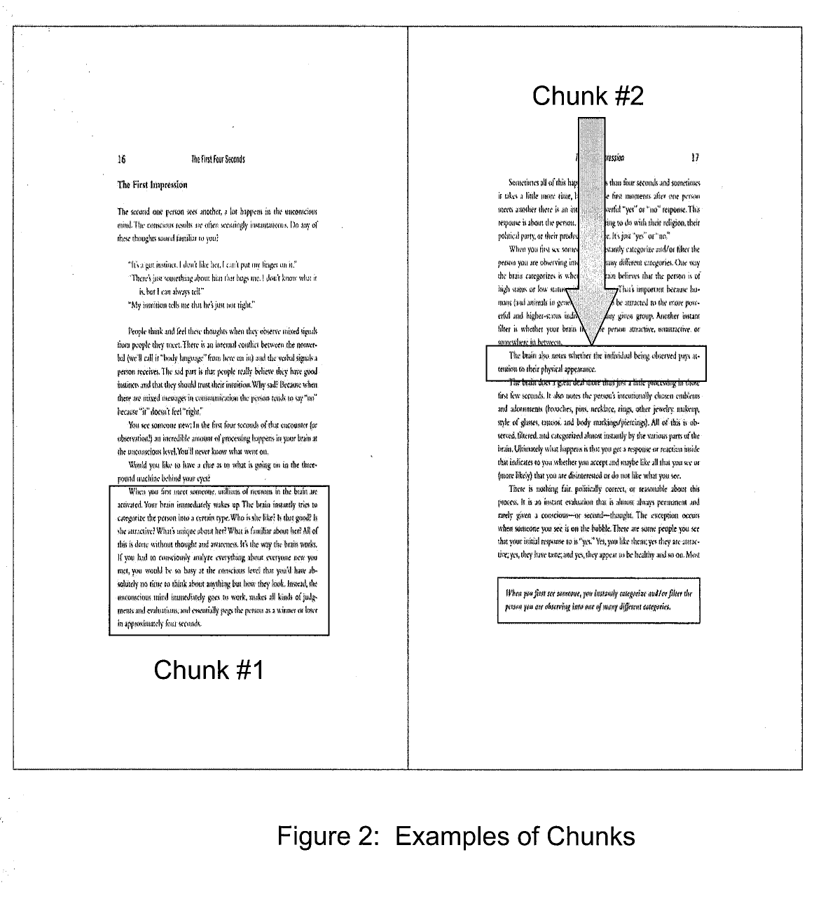

FIG. 3 illustrates the repository relational database.

FIG. 4 illustrates indexing of the repository relational database.

FIG. 5 illustrates the source relational database.

FIG. 6 illustrates how source document chunks are treated as separate queries.

FIG. 7 illustrates the similarity search software.

FIG. 8 illustrates examples of chunk results to a chunk query.

FIG. 9 illustrates content chunk results and meta data results.

FIG. 10 illustrates links to external search engines.

FIG. 11 illustrates aggregate results.

FIGS. 12A-12F schematically illustrate flow diagrams useful in describing the steps of example processes used in a system of learning.

### DETAILED DESCRIPTION

Examples of the present invention will now be described in detail for specific examples. These examples are intended merely as illustrative examples. The invention is not limited to these specific examples, but only by the language of the claims themselves.

A system and method for converting source documents into a portal or portals to be used by the user for searching provides accelerated searching and improved relevancy of information extracted from a catalogue of documents and other sources of information, such as the Internet or an intranet. Discrete representations or subsections of the initial source text may be displayed, such that the user can easily locate concepts of interest. For example, after a single click, a user will see associated reference materials. With a second click, the user may make use of the associated references to further browse the World Wide Web and other Internet resources. Initial source text is subdivided into “chunks.” For example, chunks are compared via a “more like this” similarity search to a pre-existing repository of documents. The pre-existing document repository may be subdivided into chunks. These chunks may be stored in a relational database. For example, the system allows for re-creating the full text document and for identifying such metadata as author, title, publisher, and page references, using the information stored in the relational database. A similarity search engine may be used to identify chunks from the repository which are most relevant to each chunk in a source document. For each chunk and for the aggregates of collections of chunks, the top number of specified ranked results of each more like this chunk search may be displayed and relational links may be coupled with text or graphical elements, such as hypertext links. Results may be provided in a list linked to the following: a) one or more full text sources for that resource, b) the results of the submittal of words comprising the title and authors of the given resource to one or more search engines which, for example, could be either web or enterprise based or both, and/or c) the results of the submittal of words comprising the text of the chunk retrieved from the repository to one or more search engines, which could be either web or enterprise based or both, for example.

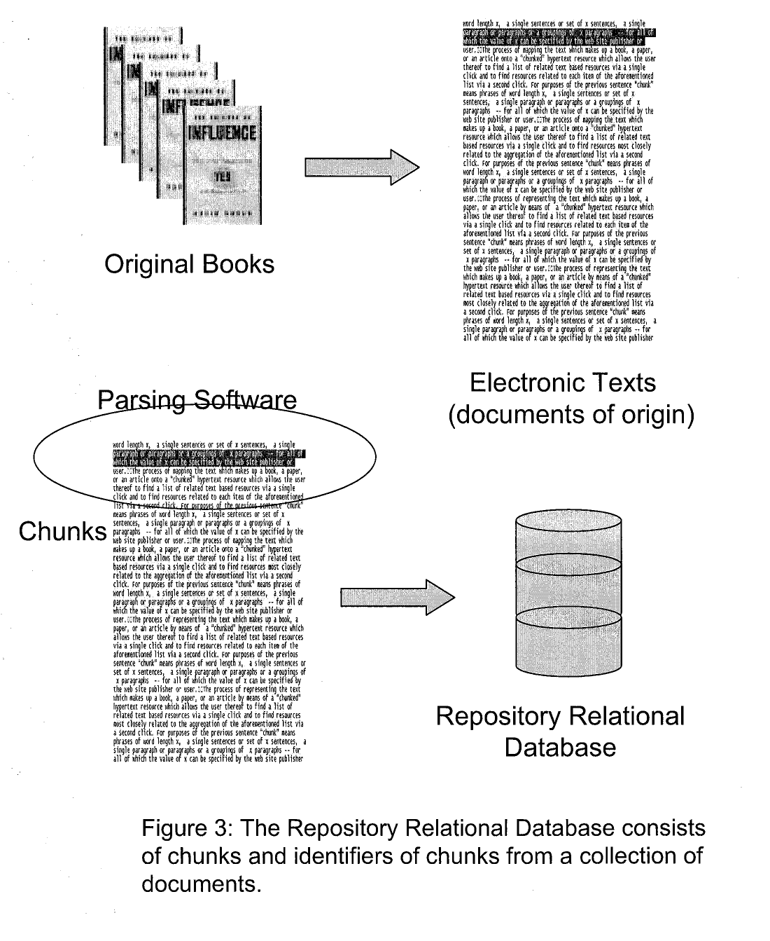

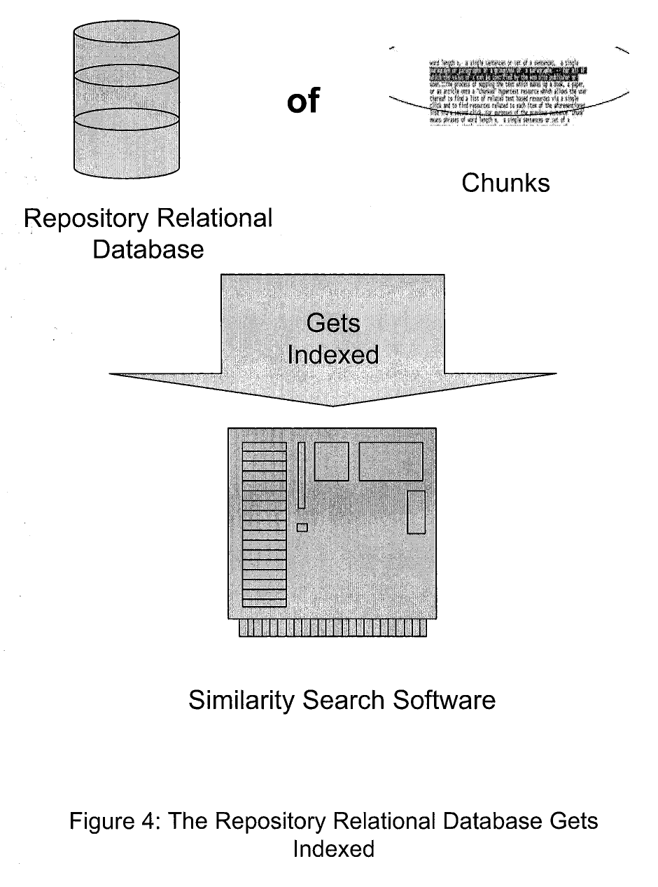

In one example, a system for converting a lengthy textual material, such as a source document, into a web portal that is relevant to a user begins with the repository provider depositing a main document repository into a relational database, as shown in FIG. 3. The repository provider makes use of parsing software to divide each document in the main document repository into chunks. The repository provider makes use of similarity search software to prepare an index of the chucks in the repository relational database, as shown in FIG. 4.

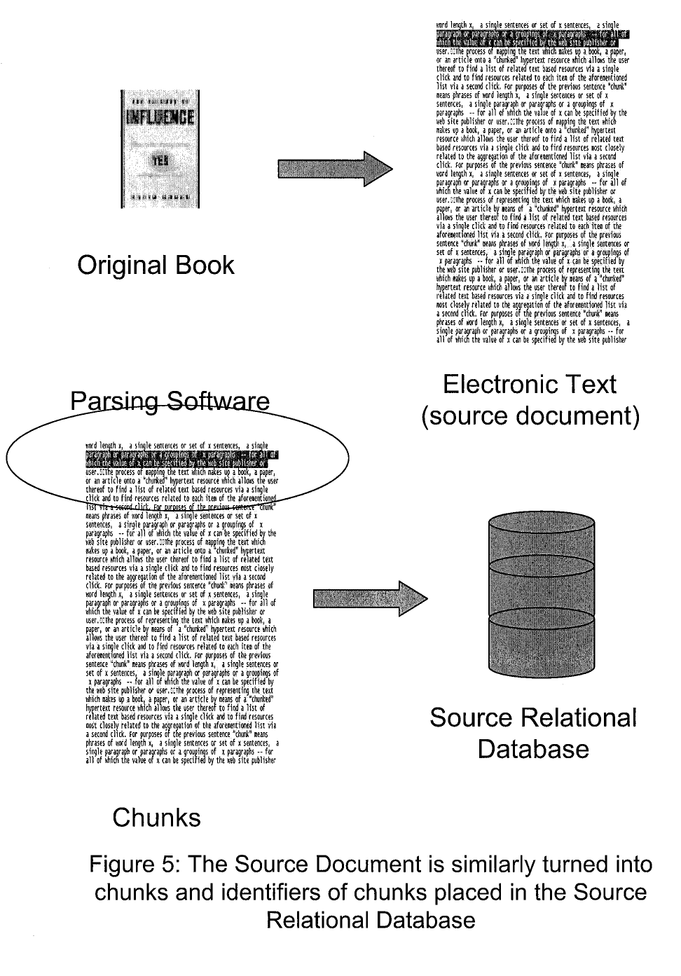

Next, a publisher or user submits a source document to an input function of a parsing and search aggregator, such as by using a query box, a file upload operation, or a system command, for example. The parsing and search aggregator may assign a query identifier to the query. The parsing and search aggregator first applies its parsing component to the source document. The source document is parsed into chucks according to the chunking rules set by the party controlling the parsing and search aggregator, as illustrated in FIG. 5. The party may be the publisher, the repository provider, or a third party. Then, the chunks are deposited in the source document relational database. Within the source document relational database the source document may be held in one or more of several formats 1) as a whole; 2) as chunks and 3) as identifiers which allow the chunks to be associated with their location within the corpus of the source document and the source document, or some subsection thereof, to be reassembled from the collection of chunks which originated within that document, or subsection thereof.

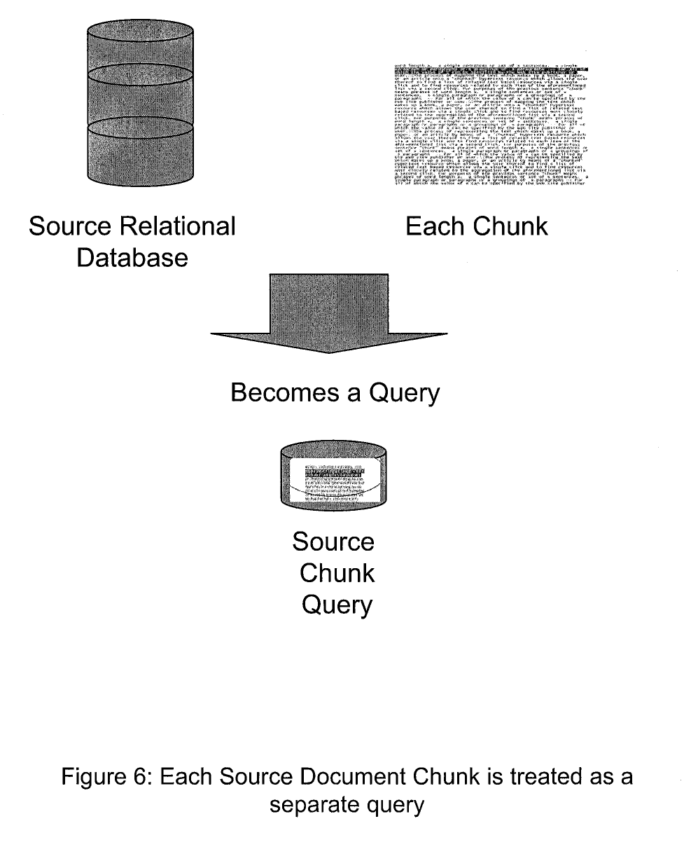

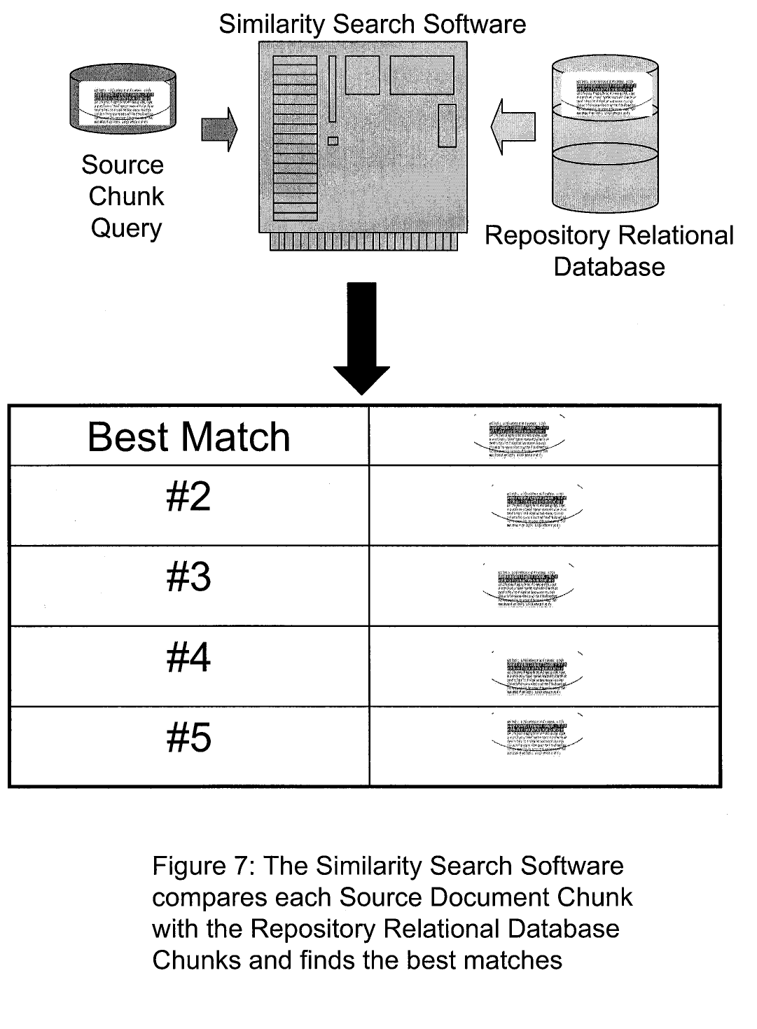

Next, as illustrated in FIG. 6, the parsing and search aggregator conducts a similarity search, which may utilize the same similarity search software or subroutines as the similarity search software used to index the main document repository, for example. Each chunk is treated as a separate query and the similarity search software component assigns an identifier to each “chunk” query. In FIG. 7, a similarity search is conducted for each chunk query with the main document repository to determine which are most similar to the chunk of the source document. The publisher is able to determine the parameters that determine how many of the most similar chunks retrieved from the main document repository are to be identified as being associated with each chunk from the source document. The chunks identified as being the most similar and within the confines of the “number of chunks to save results for” parameter are assigned identifiers and deposited with their identifiers into the source document relational database.

For example, each subsection of the source document identified by the publisher as consisting of two or more chunks may be submitted to the parsing and search aggregator to perform a weighted aggregation. The weighted aggregation sub-routine determines which chunks appear in the aggregate with respect to that section as the highest ranked. The aggregate ranking subroutine may take into account both the raw number of times a chunk from the main repository is identified as similar and the relative ranking of the identified main repository chunk within the subset of main repository chunks identified as similar with respect each given source document chunk which is a component of the section of the source document for which aggregated results are being compiled. The publisher is able to determine the parameters which determine how many of the most similar chunks retrieved from the main document repository are to be identified as being associated with each section from the source document. The chunks identified as being the most similar with respect to a given section of the source document and within the confines of the “number of chunks to save results for” parameter are assigned identifiers and deposited with their identifiers into the source document relational database, for example.

In one example, the parsing and search aggregator performs a weighted aggregation sub-routine on the source document, as a whole, to determine which chunks appear in the aggregate as the highest ranked. The aggregate ranking subroutine takes into account both the raw number of times a chunk from the main repository is identified as similar and also the relative ranking of the identified main repository chunk within the subset of main repository chunks identified as similar with respect each given source document chunk which is a component of the source document for which aggregated results are being compiled. The publisher is able to determine the parameters which determine how many of the most similar chunks retrieved from the main document repository are to be identified as being associated with the source document as a whole. The chunks identified as being the most similar with respect to the source document as a whole and within the confines of the “number of chunks to save results for” parameter may be assigned identifiers and deposited with their identifiers into the source document relational database.

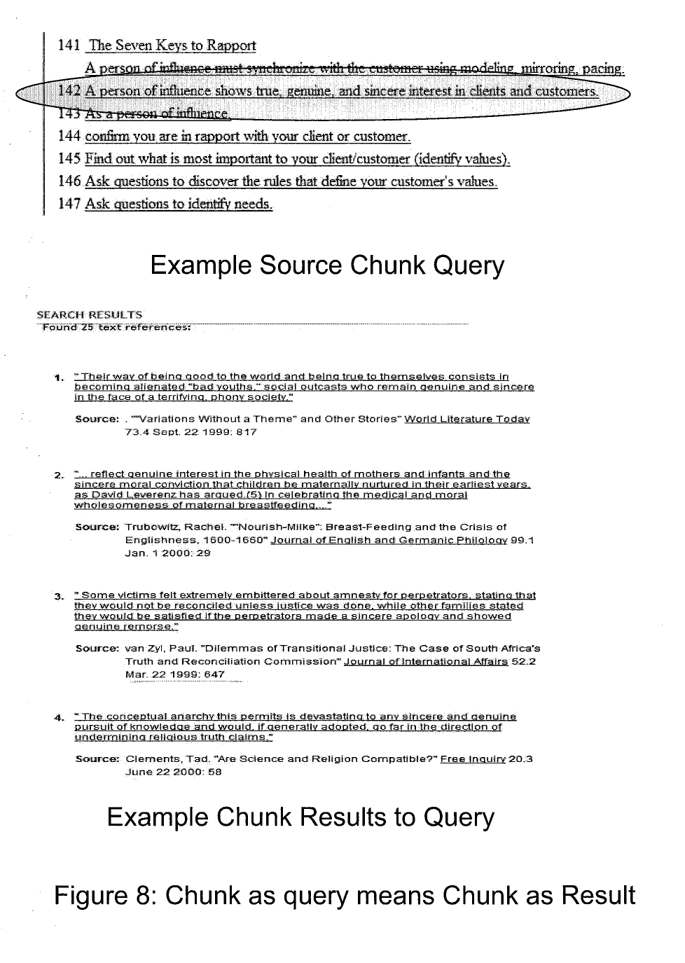

FIG. 8 illustrates an example of a portal comprising multiple html or xml or similar pages which contain information about the source document. The information may be linked by a hypertext link leading to information about documents in the main document repository. Documents in the main document repository further lead to results from one or more external search engines, for example. The portal publisher may be capable of collecting data from the source relational database to construct a hypertext linked set of html or xml or similar pages which contain links to information. For example, on an originating page, the full text of a chunk from the source document or an identifier for such chunk, may be displayed as illustrated in FIG. 8. The identifier may be an abbreviation, an outline entry, a section heading, a paraphrase or a code, for example. The full text or its identifier may be hypertext linked to the linked material page or sub-page identified with that respective source document chunk. In another example, a linked material page may display the full text of each chunk identified as similar to a chunk from the main document repository or an identifier for such chunk. The identifier may be an abbreviation, an outline entry, a section heading, a paraphrase or a code. The full text or its identifier may be hypertext linked to the linked material page or sub-page identified with that respective main repository document chunk. The contents of the link may be a pointer to the full text of the related document from the main document repository or some publisher defined subsection thereof which, for example, could include an intermediate step authenticating the user with respect to the document rights management processes associated with that document or section thereof from the main document repository. Alternatively, contents of the link may be a pointer with appropriate application programming interface information for submittal of the full text, or a portion thereof, of the identified chunk from the main document repository, the metadata, or a portion thereof, describing the document from the main document repository from which the chunk was extracted or parsed, or a combination of these.

On a subsequently linked material page, the full text of a document from the main document repository, or the appropriate sub section thereof, may be displayed in accordance with the full text display rules established by the main document repository provider, for example. This may include, as an intermediate step, one or more pages authenticating the user with respect to a document rights management process associated with that document, or section thereof.

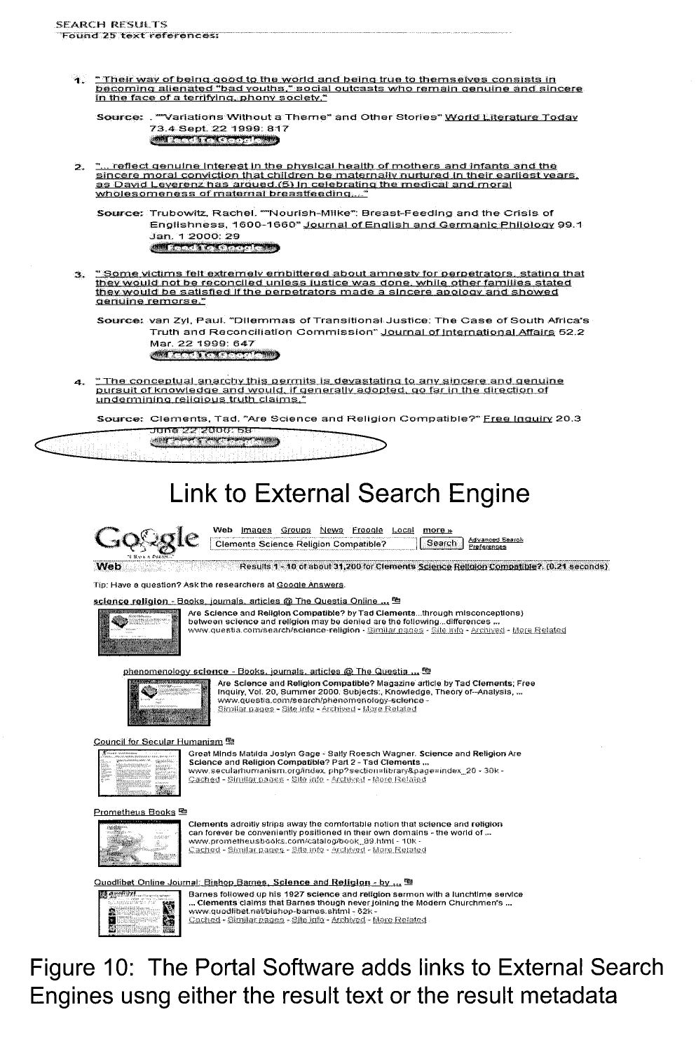

On another subsequently linked material page, the search results from the submittal of the full text, or a portion thereof, of the identified chunk from the main document repository; the metadata or a portion thereof describing the document from the main document repository from which the chunk was extracted or parsed; or a combination thereof may be interfaced to an external search engine in accordance with its application programming interface, such as illustrated in FIG. 10. For example, this may include as an intermediate step authenticating the user with respect to the document rights management processes associated with the external search engine or the document repository to which it provides access.

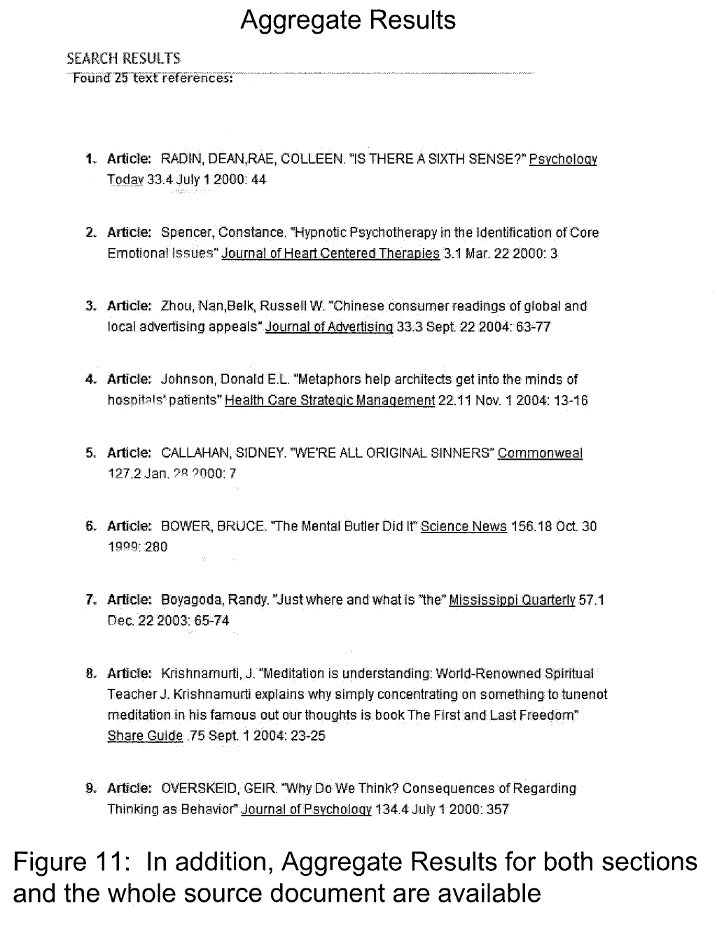

Aggregate results are illustrated in FIG. 11, which may be displayed on an originating page. Full text or an identifier is hypertext linked to a linked material page or sub-page identified with that respective source document section by the aggregator system. A link may be formed for the most closely related documents from an intermediate database. Another link may be provided for feeding information about the most closely related documents to a search engine. For example, various identifying information may be passed to the search engine, such as the author and title of a reference to the chunk of an intermediate document stored in a relational database. The identifying information may be author and title for a novel or paper. The identifying information may be patent number, inventor, title, art unit, assignee or any combination of these, if the intermediate document repository is the entire United States Patent & Trademark Office or another database containing the text of patents, for example. Alternatively, text may be fed to the internet search engine directly from the chunk of the intermediate document. In alternative examples, the designer of the system chooses the mode of operation, the user is permitted to choose the mode of operation, or portals display results for both identifying information and text from chunks.

In one example, a portal built is displayed around a biography of a baseball player. The initial display of information summarizes the content of the biography itself. As the user clicks on links, subsequent pages reveal links to documents in the publisher's repository about the baseball player, his team, his home town, the team's home town, and major then current events which occurred at various points during the baseball player's life. For example, if the baseball player played for New York and was alive during 2001, some links would lead to exploration of the World Trade Center collapse. Other links would talk about subways and their role in life in New York. Still other links would discuss the college the player attended. Many links would be about baseball but many others would be about items which are tangential to the overall subject of the biography but highly relevant to a given chunk of text.

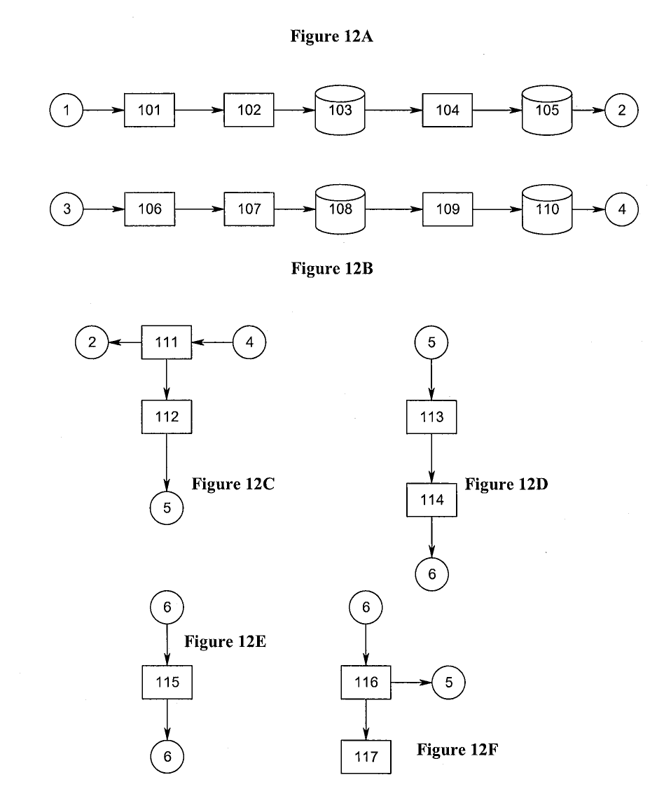

In one example, such as illustrated in the schematic flow diagram of FIG. 12, a system of learning segments 107 a large source document 106 as an agglomeration of pieces or chunks, compares 11 the chunks of the source document to an agglomeration of chunks 102 of authenticated intermediate documents 101 stored in a database 103 that has been indexed 104 by a similarity indexing algorithm and stored in an updated relational database 105. The comparison 111 is delivered to a portal 112 for display by the portal 113, according to rules provided for display of results. For example, the results may be displayed by links in a hypertext document of the source document 106 having links from text in the source document 106 to the most closely related chunks of the intermediate document 101. By selecting a link in the hypertext document, a user may be redirected to a list of the most closely related chunks of the intermediate document 101 for a concept, a chunk or a plurality of chunks contained in the source document 106, for example. The list may include additional links to take the user to the portion of the intermediate document 101 or may feed keywords or a phrase to a search engine 114 capable of interfacing with the internet to perform a web search. The feed 114 may strip punctuation, non-essential words, and stop words, such as periods, commas, a, the, and, or, and the like, as is known in the art, prior to sending a string to the search engine. Then, the results of the search are displayed 115 using either the search engine's own portal or based on display rules for another portal display software.

The portal 113 is capable of displaying a list of the most closely related agglomerated pieces from the authenticated intermediate database to the source document, using one of a variety of similarity searches and output formats. The portal 113 provides a format for presenting results of the similarity search. In another example, the portal 113 may present results for a plurality of chunks, such as paragraphs, chapters or other agglomerated sections of the document, which are linked to a portal window that shows a list of references ranked by relevance based on the number of related references to each chunk within the intermediate database 101.

The number of documents displayed in the list may be limited to a specific number, such as 25, or to a certain number per page. In one example, the relevance is a raw statistical ranking based solely on the number of references to a specific chunk of an intermediate document 101 within a plurality of chunks of the source document 106. Then, the order of display may be selected from the highest number of references to the lowest. In another example, the ranking of relevance may use a weighted algorithm. One example of a weighted algorithm used for an agglomeration of chunks of a source document 106 assigns a value to each reference based on the position in a list of related intermediate documents 101 of the reference, i.e. the relevance, such as 1.0 for an entry in positions 1-5, 0.8 for 6-10, 0.6 for 11-15, 0.4 for 16-20, and 0.2 for 21-25. Then, the points received by relevant chunks of the intermediate document 101 are totaled, and the chunks receiving the highest score are listed in order from highest score to lowest score. The portal may show the top 25 based on this measure of relevance or any other number or ranking of relevance, for example.

The schematic flow diagram of FIG. 12 is one example of a system for learning, which matches portions of the large source document or the entire large source document against an intermediate document repository prior to formulating and feeding a search string to a search engine. The intermediate step helps to focus both the number and relevance of websites that an internet search engine returns for a particular chunk or plurality of chunks from a source document 106. A repository provider places one or more original documents, or portions thereof, in a main document repository 101. A parsing algorithm 102, which may be provided by any type of parsing software, is capable of segmenting one or more original documents into chunks.

In one example, the original documents include a half million documents that are separated into chunks by a parsing algorithm 102, such as an algorithm that chunks each document according to the following rule: 2 sentences, unless the 2 sentences exceeds 40 words, then 40 words. The partial sentence counts as a complete sentence for the next chunk [Rule A]. Other chunking algorithms may be specified. For example, chunks may be identified as follows: single sentences not to exceed 15 words [Rule B].

In one example, 40 word limit in the double sentence algorithm [Rule A] and the 15 word limit in the single sentence algorithm [Rule B] are programmed to identify proper nouns as a single word, in one example of the system for learning. The identification and use of proper nouns as a single word is useful, especially if the proper nouns with multiple words tend to have a different meaning together than when used separately. Names of authors, cities, countries and other proper names are often identifiable and significant. For example, the proper name “New York” means something very different than “new” or “York” taken individually. Although a search based on “York” might discover references to “New York,” it would certainly find many irrelevant references. A search of one popular search engine shows 2,050,000,000 hits for New York, while new and York, individually, had 14,300,000,000 hits. While “New York” had far fewer hits, even this search produced a volume of hits that is completely unmanageable. The purpose of the system is to provide a tool that may be used as a source document, such as personal notes about New York, a song about New York, an article about New York, all the articles in the Sunday New York Times or a book about New York, to narrow a search about New York to the websites and articles most relevant to the source document. A search for the words “I like a Gershwin tune how about you” resulted in only 633,000 hits, while adding “I like New York in June” in front reduced the search to only 150,000 hits.

While adding more search terms makes a search return fewer hits, it does not necessarily produce a more focused and relevant search. The system of learning helps to provide focus and relevancy to a search based on a main document repository 101 of origin documents, which may be limited to known relevant documents or may merely be a library of authenticated documents. This main document repository 101 may be divided into chunks according to a parsing algorithm 102, which results may be stored in a relational database 103, for example.

Now, referring to FIGS. 12A-F, the relational database is capable of recording the identifying information for each of the chunks 105. A similarity search may be used to index the chunks 104 that are maintained in the updated relational database 105. The similarity search 104 may use any similarity search algorithms, such as semantic space vector analysis, schema analysis, latent semantic analysis, or attribute analysis. One example of a similarity analysis is Autonomy, which treats a similarity search as a Bayesian inference/statistical pattern recognition problem. The repository relational database 105 is now prepared to be used to focus a search using a source document.

In one example, the entire patent database of the United States Patent & Trademark Office (USPTO) may be used as a main document repository 101. This is divided in chunks by parsing 102, the chunks are stored in a relational database 103, the chunks are indexed 104 using a Bayesian inference/statistical analysis package, and the relational database is updated with the indexing 105. The user may then submit a source document 106, such as a disclosure document, which is compared 111 to the indexed chunks of the USPTO database 105, providing a statistical correlation between chunks 107 of the source document 106 with chunks of the USPTO database 105. The top 25 results for each chunk of a source document 106 is fed to a portal 112 and displayed 113. In this example, it is thought, without being limited in any way, that the size of the chunks for the relational database 105 should be selected as single paragraphs not to exceed 100 words, whichever is less. A 250 word paragraph would be parsed into 3 chunks of the first 100 words, the second 100 words and the last 50 words, assuming that none of the words were proper names, for example. A ten word paragraph would be parsed into a single paragraph, according to the example rule.

Examples of the present invention use hardware and software to transform and store data, as is known in the art. This data is used to prepare and return searches in a system of learning that is further described in the following method.

A repository provider causes the main document repository to be deposited into the relational database and makes use of parsing software to divide each document in the main document repository into chunks. The provider makes use of similarity search software to prepare an index of the chucks in the repository relational database. See FIGS. 3 and 4 which illustrate an example of this process.

The publisher submits the source document to the input function, such as a query box, a file upload, or simply a command of the parsing and search aggregator. The parsing and search aggregator assigns a query identifier to the query.

The parsing and search aggregator first applies its parsing component to the source document. The source document is parsed into chucks according to the chunking rules set by the party controlling the parsing and search aggregator, such as a publisher, a repository provider, or a third party. The chunks are deposited in the source document relational database. Within the source document relational database the source document may be stored in several formats: as a whole; as chunks; and as identifiers which allow the chunks to be associated with their location within the corpus of the source document and the source document some subsection thereof to be reassembled from the collection of chunks which originated within that document or section thereof, as shown in FIG. 5, for example.

The parsing and search aggregator then submits each chunk to a similarity search software component, such as same similarity search software or subroutines as the similarity search software used to index the man document repository. Each chunk is treated as a separate query and the similarity search software component assigns an identifier to each “chunk” query, as shown in FIG. 6.

For example, the similarity search software component of the parsing and search aggregator determines the chunks from the main document repository are most similar to the chunk of the source document, which is submitted as content of the query. The parameters which determine how many of the most similar chunks retrieved from the main document repository are to be identified as being associated with each chunk from the source document may be capable of being changed by the user and/or publisher. The chunks identified as being the most similar and within the confines of the “number of chunks to save results for” parameter are assigned identifiers and deposited with their identifiers into the source document relational database, as represented in FIG. 7.

For each subsection of the source document identified by the publisher as consisting of two or more chunks, the parsing and search aggregator performs a weighted aggregation sub-routine to determine which chunks appear in the aggregate with respect to that section as the highest ranked. The aggregate ranking subroutine takes into account both the raw number of times a chunk from the main repository is identified as similar and the relative ranking of the so identified main repository chunk within the subset of main repository chunks identified as similar with respect each given source document chunk which is a component of the section of the source document for which aggregated results are being compiled. The publisher is able to determine the parameters which determine how many of the most similar chunks retrieved from the main document repository are to be identified as being associated with each section from the source document. The chunks identified as being the most similar with respect to a given section of the source document and within the confines of the “number of chunks to save results for” parameter are assigned identifiers and deposited with their identifiers into the source document relational database.

For the source document as a whole, the parsing and search aggregator performs a weighted aggregation sub-routine to determine which chunks appear in the aggregate as the highest ranked. The aggregate ranking subroutine takes into account both the raw number of times a chunk from the main repository is identified as similar and also the relative ranking of the so identified main repository chunk within the subset of main repository chunks identified as similar with respect each given source document chunk which is a component of the source document for which aggregated results are being compiled. The publisher is able to determine the parameters which determine how many of the most similar chunks retrieved from the main document repository are to be identified as being associated with the source document as a whole. The chunks identified as being the most similar with respect to the source document as a whole and within the confines of the “number of chunks to save results for” parameter are assigned identifiers and deposited with their identifiers into the source document relational database.

The portal consists of multiple html or xml or similar pages which contain information about the source document and which lead to information about documents in the main document repository and which then further lead to results from one or more external search engines. The portal publisher collects data from the source relational database to construct a hypertext linked set of html or xml or similar pages which contain links to the following information.

As displayed on the originating page, the text of a chunk from the source document or an identifier for such chunk may be displayed. An identifier may be an abbreviation, an outline entry, a section heading, a paraphrasing or a code. The text, in whole or in part, or the identifier is displayed is hypertext linked to the linked material page or sub-page identified with that respective source document chunk, as shown in FIG. 8. The full text of each document identified as similar to the main document repository or the appropriate sub section thereof in accordance with the full text display rules established by the main document repository provider may be displayed on the subsequent linked material page. This may include as an intermediate step one or more pages authenticating the user with respect to the document rights management processes associated with that document or section thereof from the main document repository. Alternatively, in FIG. 11, a process is shown that displays results for an aggregation of chunks, which result from a weighted average of the results for each of the chunks. In this alternative, the results may be displayed similarly to the results presented for each chunk; however, the results will be aggregated and weighted to list the results most similar based on a weighted average over the chunks combined in an aggregation, such as the full source document, a chapter, or some other portion of the full source document. Display of results for both separate chunks and aggregations of chunks may be provided in a single display, separate displays, or as an option. The remaining steps apply equally well to display of results based on similarity analysis of chunks and aggregated chunks, and reference is made only to chunks as one example.

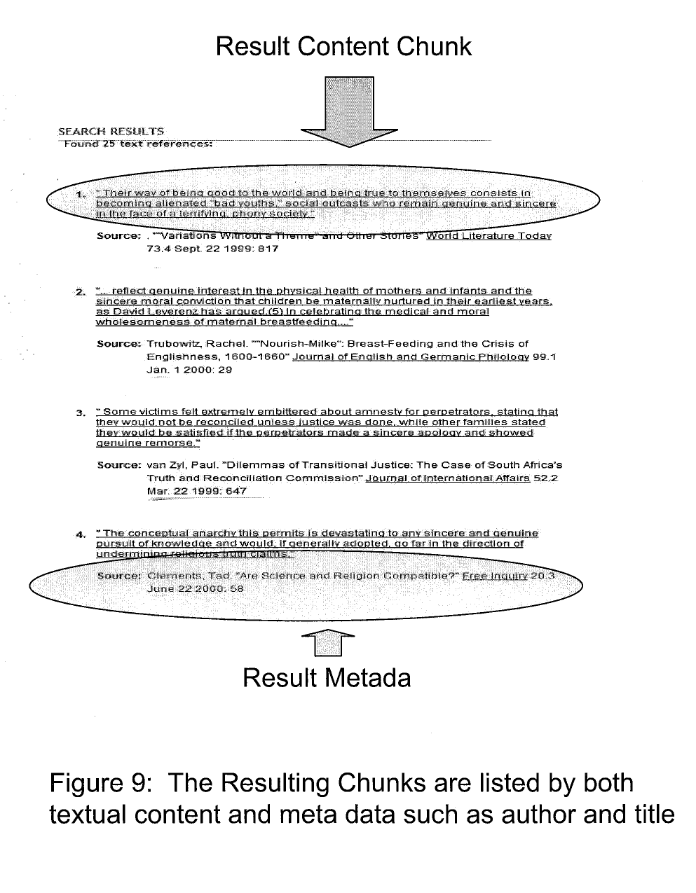

As displayed on a page of material linked to the text displayed on the originating page, the text, in whole or part, of each chunk identified as similar to the main document repository to be found in the source document relational database or an identifier, as disclosed previously, for example. The full text or its identifier as so displayed is hypertext linked to the linked material page or sub-page identified with that respective main repository document chunk. The contents of this link include a pointer to the full text of the related document from the main document repository or some publisher defined subsection, which could include an intermediate step authenticating the user with respect to the document rights management processes associated with that document or section thereof from the main document repository; or a pointer. If a pointer, it is desirable to have appropriate application programming interface information for submittal of at least a portion of the text of the identified chunk from the main document repository; at least a portion of the metadata describing the document from the main document repository from which the chunk was extracted or parsed; or any combination thereof, as shown in FIGS. 8 and 9.

The search results from the submittal of any portion or all of the full text of the identified chunk from the main document repository; at least a portion of the metadata describing the document from the main document repository from which the chunk was extracted or parsed; or any combination thereof is displayed to the external search engine in accordance with its application programming interface. This may include as an intermediate step one or more pages authenticating the user with respect to the document rights management processes associated with the external search engine or the document repository to which it provides access, as illustrated in FIG. 10.

The portal software is capable of gathering the results from simulation analysis and applying the protocols and rules of any content management system or other set of standardized style processes to ensure a uniform look and feel to the user interface. A user of a portal is presented with information relating to the source document and an interlinked set of hypertext links to related material from the main document repository and from submittals to external search engines, for example.

In one example, a portal built around a biography of a baseball player may display, initially, summaries of the content of the biography itself. As the user clicks on links, subsequent pages may reveal links to documents in the publisher's repository about the baseball player, his team, his home town, the team's home town, and major then current events which occurred at various points during the baseball player's life. A baseball player who played for New York and was alive during 2001 might lead some websites about the collapse of the World Trade Center. Other links might refer to subways and their role in life in New York. Still other links might refer to the college the player attended. Many links would be about baseball, but many others would be about items which may seem tangential to the overall subject of the biography but highly relevant to a given chunk of text. For example, an analogy may be drawn between examples of the present invention and library stacks. Browsing for a random book and turning to a random paragraph is usually not a productive way of finding specific information in a library. However, flipping through the pages and looking at the titles or covers of other books situated on the same shelf or in the same bookcase will often reveal something of interest, especially if the card catalog was first searched in order to identify the shelf of most interest to the researcher. Similarly, analyzing the most closely related chunks from the documents chunks stored in a relational database compared to a source document of interest provides a targeted search of references that are statistically related to the source document. Exploring the closest links provides a method that quickly yields useful information relevant to the source document. A person of ordinary skill in the art will understand from the examples disclosed that many combinations and variations of the disclosed examples are apparent after reviewing the drawings and description.

FIGS. 12A-F schematically illustrate flow diagrams useful for describing an example of a process used in a system of searching. A repository provider enters one or more documents of origin 1 in a repository of origin documents 101. Preferably, the documents have text or have been converted to text, but the documents may contain both text and graphical elements, and the combined text and graphics may be retrievable in the repository of origin documents 101. A parsing system 102 parses all or a subset of the documents of origin into chunks. The chunks are stored 103 in an origin database, such as a relational database. Similarity search software indexes 104 the chunks and updates 105 the entries in the origin database to reflect the indexing of each of the chunks and/or other statistical information useful to the repository provider and/or user.

A user of the system submits 3 a source document or documents into the system 106. A parsing system 107, which may be the same parsing system 102 used in parsing the origin document(s), parses the source document into chunks. The chunks of the source documents may be stored 108 in a source relational database. A search aggregator assigns 109 an identifier and indexing information to each of the chunks, and the identifier and indexing information is updated 110 within the source relational database, which may be a separate database or may be integrated with the origin database. Information about the content and indexing of the source database and the origin database may be extracted 4, 2 by the system from each of the sets of database entries.

In FIG. 12C, an example of a similarity listing subsystem extracts information from the origin database 2 and the source database 4 and compares the information, such as by using a similarity search system 111, which may be the same system as used for the similarity search during indexing of the origin document or a different system. At least a portion of the origin database is compared 111 with database entries of the source document, and related chunks are identified 112 and may be ranked in order of similarity in a list 5, for example.

Now referring to FIG. 12D, an example is schematically shown that takes the list 5 and processes the list 5 by applying 113 protocols and rules of a content management system or other set of standardized style processes to create a uniform look and feel of a display of the list 5 to a user. The display may be viewing on a monitor or printing of the list 5 on a printer after processing 113. The user may select 114, such as by clicking a pointing device on a link, one or more portions of the origin document, the source document, or both thereof from the list 5 after processing 113. The selected portions may be output 6 for further processing. FIG. 12E illustrates that selected information may be displayed 115 and may be output 6 for further processing, for example, such as by manually selecting information for further processing or by automatically sending the output 6 to a search engine. As shown schematically in FIG. 12F, for example, the output 6 may be input to an internet or intranet search engine as a search string querying 116 the database of the search engine. The results of the querying 116 may be presented to the user using the display parameters provided by the search engine 117 or by outputting 5 the results into a content management system 113, which may be the same content management system used in applying protocols and rules to the list output by the similarity listing subsystem to apply a standardized look and feel to the information returned by the search engine or search engines, regardless of the search engine or search engines chosen for processing of the query.

What is claimed:

1. A system for converting a source document into a search portal for use by a user, comprising:
source database entries from one or more parsed and aggregated source documents, the one or more source documents or locations to retrieve the one or more source documents being entered by the user of the system;
origin database entries from one or more parsed and indexed origin documents;
a similarity search system comparing a set of the source database entries to a set of the origin database entries producing a list of related links ranked at least partially by similarities determined by comparing of the set of the source database entries and the set of the origin database entries;
constructing a hypertext linked portal for viewing of the list of related links.

2. The system of claim 1, wherein the hypertext linked portal displays the list of related links comprising:
one or more full text source documents;
titles and authors from a query of one or more search engines based on a search including text of one or more source database entries associated with one or more source database entries;
results of submittal of origin database entries to one or more search engines; or
a combination thereof.

3. The system of claim 2, wherein the hypertext linked portal displays the list of related links comprising results of submittal of origin database entries to one or more search engines, and the set of origin database entries to submit is selected by determining the highest ranked origin database entries from a weighted aggregation.

4. The system of claim 2, wherein the hypertext linked portal displays the list of related links comprising a combination of:
one or more full text source documents;
titles and authors from a query of one or more search engines based on a search including text of one or more source database entries associated with one or more source database entries; and
results of submittal of origin database entries to one or more search engines.

5. The system of claim 1, further comprising a search engine querying system, such that selecting one or more of the related links submits a search string based on the text of one or more source database entries or origin database entries and displays search results from one or more search engines.

6. The system of claim 1, wherein the system further comprises authenticating the user using a document rights management subsystem prior to retrieval of information, content or a document from a search engine, intranet repository or database.

7. A process for performing a search query comprising the steps of:
creating a source document relational database and a repository relational database;
conducting a search query for a search term and subdividing the search query into chunks through a parsing and searching aggregator;
depositing the chunks from the search query into the source document relational database;
depositing a main document repository into the repository relational database;
subdividing the main document repository into chunks and using a similarity search software to prepare an index of relevant chunks;
conducting a similarity search of the index of relevant chunks with the chunks from the source document relational database;
using the parsing and search aggregator by performing a weighted aggregation by determining which relevant chunks are most similar with the chunks from the source document relational database and within confines of a number of chunks to save results parameter,
assigning identifiers to the chunks identified as most similar and depositing the chunks into the source document relational database.
and collating a resulting entry of similar chunks.

8. The process of claim 7, further comprising a step of using the resulting entry of similar chunks to construct a hypertext web link for a web portal, the web link being displayed to an user.

9. The process of claim 7, further comprising a step of
conducting a second search query of the resulting entry of similar chunks and subdividing the second search query into chunks;
depositing the chunks of the second search query into a source document relational database;
using the parsing and search aggregator by performing a weighted aggregation by determining which relevant chunks are most similar with the chunks from the source document relational database and within confines of a number of chunks to save results parameter,
collating a resulting entry of similar chunks, and
using the resulting entry of similar chunks to construct a hypertext web link for a web portal, the web link being displayed to an user.

10. The process of claim 7, wherein the step of conducting the search query uses an input function of the parsing and search aggregator, such as by using a query box, a file upload operation, or a system command.

11. The process of claim 7, wherein the step of conducting the search query includes holding information of the search query as one of the following or combinations thereof: as a whole, chunks and as identifiers which allow the chunks to be associated with the chunks' location in a source document containing the search query or a section of the source document.

12. The process of claim 7, wherein the step of using the parsing and search aggregator uses a same similarity software as the step of conducting a similarity search.

13. The process of claim 7, further comprising a step of using the resulting entry to link to a hypertext web link leading to a source of the entry coming from the main document repository.

14. The process of claim 13, wherein the step of using the resulting entry includes leading the source of the entry coming from the main document repository to results from one or more search engines.

15. The process of claim 14, wherein the step of using the resulting entry includes an intermediate step, requiring a user a document rights management process associated with the search engines or the document repository.

16. The process of claim 7, further comprising a step of forming an intermediate database after the step of collating, forming a web link to the resulting entry from the intermediate database or to a search engine.

17. A method for creating a search portal, comprising:
generating dynamically one or more source documents including text;
parsing the text of the source documents, creating source chunks;
aggregating the chunks into source database entries;
parsing one or more origin documents including text, creating origin chunks of the text;
indexing origin chunks, creating origin database entries having indexing information;
comparing a set of the source database entries to a set of the origin database entries, using a similarity search system;
ranking a list of related links at least partially according to similarities between the set of the source database entries and the set of the origin database entries;
selecting a set of database entries selected from the group consisting of:
the set of the source database entries;
the set of the origin database entries; or
both thereof;
submitting to one or more search engines a search string selected from the set of database entries selected in the step of selecting;
receiving output from the one or more search engines used in the step of submitting;
constructing a hypertext linked portal for viewing of the output; and
displaying the output in the hypertext linked portal, wherein the hypertext linked portal displays a link of a uniform resource locator for one or more of the source documents and the results from the one or more search engines.

18. The method of claim 17, wherein the search string selected from the set of the origin database entries is submitted to the one or more search engines, in the step of submitting, and the step of selecting selects the set of origin database entries based on the highest rank according to a weighted aggregation of similarity.

19. The system of claim 17, further comprising:
authenticating of the user using according to a document rights management system; and
authorizing the user to retrieve information, content or a document from a search engine, intranet repository or database, if the user is authorized to have retrieve the information under the document rights management system.

20. A system using the method of claim 17.
